(19) United States
(12) Patent Application Publication
(10) Pub. No.: US 2025/0184742 A1
(43) Pub. Date: Jun. 5, 2025

(54) PROXIMITY-BASED SIM CARD SUBSCRIBER AUTHENTICATION

(71) Applicant: CenturyLink Intellectual Property LLC, Denver, CO (US)

(72) Inventors: John R.B. Woodworth, Amissville, VA (US); Dean Ballew, Sterling, VA (US)

(73) Assignee: CenturyLink Intellectual Property LLC, Denver, CO (US)

(21) Appl. No.: 18/961,807

(22) Filed: Nov. 27, 2024

Related U.S. Application Data
(60) Provisional application No. 63/606,136, filed on Dec. 5, 2023.

(51) Int. Cl. H04W 12/43; H04W 8/28; H04W 12/63

(52) U.S. Cl. CPC H04W 12/43; H04W 8/28; H04W 12/63

(57) ABSTRACT

Examples of the present disclosure describe systems and methods for preventing unauthorized Subscriber Identity Module (SIM) card swapping by implementing proximity-based SIM card subscriber authentication. In examples, when a communications service provider receives a request to move a subscriber phone number to a new SIM card, the new SIM card is activated in a locked state. In the locked state, certain features (e.g., receiving calls and text messages/texts) are disabled until the subscriber's identity is confirmed using proximity-based authentication. In examples, proximity-based SIM card subscriber authentication is performed using a token provided by a physical authentication device within proximity to a subscriber mobile device including the new SIM card. Upon successful proximity-based SIM card subscriber authentication, the new SIM card is activated in an unlocked state.

### CROSS-REFERENCE TO RELATED APPLICATIONS

This application claims the benefits of U.S. Provisional Application No. 63/606,136 filed Dec. 5, 2023, entitled “Proximity-Based SIM Card Subscriber Authentication,” which is incorporated herein by reference in its entirety.

### BACKGROUND

Various digital security threats exist in today's digital age. One example relates to the customary use of mobile devices and SMS (Short Messaging Service) messages for primary (re)verification methods (e.g., multi-factor authentication (MFA)) for sensitive accounts, such as email, social media, cryptocurrency wallets, financial accounts, etc. This practice exposes sensitive accounts to security vulnerabilities, such as when an adversary intercepts MFA codes sent to a user's mobile device number, thereby gaining access to the user's sensitive accounts. It is with these observations in mind, among others, that aspects of the present disclosure were conceived.

### SUMMARY

The present disclosure describes a system and method for providing proximity-based SIM card subscriber authentication. In examples, proximity-based SIM card subscriber authentication is performed when a request is received to move a subscriber phone number to a new SIM card. In examples, in response to the request, the new SIM card is activated in a locked state until proximity-based SIM card subscriber authentication is completed. Proximity-based SIM card subscriber authentication may include verification of a token provided by a physical authentication device within proximity to a subscriber mobile device including the new SIM card. Upon successful proximity-based SIM card subscriber authentication, the new SIM card is activated in an unlocked state.

One aspect of the present disclosure includes a method, comprising: receiving a request to transfer a subscriber phone number from a first Subscriber Identity Module (SIM) card to a second SIM card; linking, in an account of a subscriber, the subscriber phone number to the second SIM card; activating the second SIM card in a locked state; receiving, from a mobile device including the second SIM card, a token obtained from a physical authentication device within proximity to the mobile device; verifying the token; and activating the second SIM card in an unlocked state.

Another aspect of the present disclosure includes a system, comprising: at least one processing unit; and memory storing instructions that, when executed by the at least one processing unit, cause the system to: receive a request to transfer a subscriber phone number included in an account of a subscriber from a first Subscriber Identity Module (SIM) card to a second SIM card; link the subscriber phone number to the second SIM card; activate the second SIM card in a locked state; receive, from a mobile device including the second SIM card, a token obtained from a physical authentication device within proximity to the mobile device; verify the token; and activate the second SIM card in an unlocked state.

Another aspect of the present disclosure includes a method, comprising: receiving a request to transfer a subscriber phone number from a first Subscriber Identity Module (SIM) card to a second SIM card; linking, in an account of a subscriber, the subscriber phone number to the second SIM card; activating the second SIM card in a locked state; determining whether a valid token is received from a mobile device including the second SIM card within a time threshold of receiving the request, wherein the valid token is obtained from a physical authentication device within proximity to the mobile device; and when the valid token is received, activating the second SIM card in an unlocked state.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a block diagram showing an example system in which a system may be implemented for providing proximity-based SIM card subscriber authentication according to an example.

FIG. 2 is a block diagram showing an example data flow for providing proximity-based SIM card subscriber authentication according to an example.

FIG. 3 is a block diagram showing another example data flow for providing proximity-based SIM card subscriber authentication according to an example.

FIG. 4 is a flowchart illustrating operations of a method for providing proximity-based SIM card subscriber authentication according to an example.

FIG. 5 is a block diagram of a computing device with which one or more aspects of the disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Various digital security threats exist in today's digital age. One example relates to the use of mobile devices and SMS (Short Messaging Service) for primary (re)verification methods (e.g., multi-factor authentication (MFA)) for sensitive accounts, such as email, social media, cryptocurrency wallets, financial accounts, etc. This practice has exposed a security vulnerability in the form of Subscriber Identity Module (SIM)-swapping, a malicious technique that jeopardizes user/subscriber identities and financial stability. SIM-swapping entails unauthorized individuals gaining control of a subscriber's SIM card, and thus, the subscriber's mobile phone number. For instance, an unauthorized individual (an adversary) may impersonate the subscriber in an attempt to have the subscriber's phone number transferred from a first SIM card in the subscriber's possession to a second SIM card held by the adversary. The adversary may intercept MFA codes sent via SMS to the subscriber's phone number, thereby gaining illicit access to sensitive accounts. Accordingly, secure verification methods are needed to safeguard subscribers from such digital threats.

Examples of the present disclosure describe systems and methods for preventing unauthorized SIM card swapping by implementing proximity-based SIM card subscriber authentication. In examples, when a communications service provider receives a request to move a subscriber phone number to a new SIM card, the new SIM card is activated in a locked state. In the locked state, certain features (e.g., receiving calls and text messages/texts) are disabled until the subscriber's identity is confirmed using proximity-based authentication. In examples, proximity-based SIM card subscriber authentication is performed using a token provided by a physical authentication device. Upon successful proximity-based SIM card subscriber authentication, the new SIM card is activated in an unlocked state.

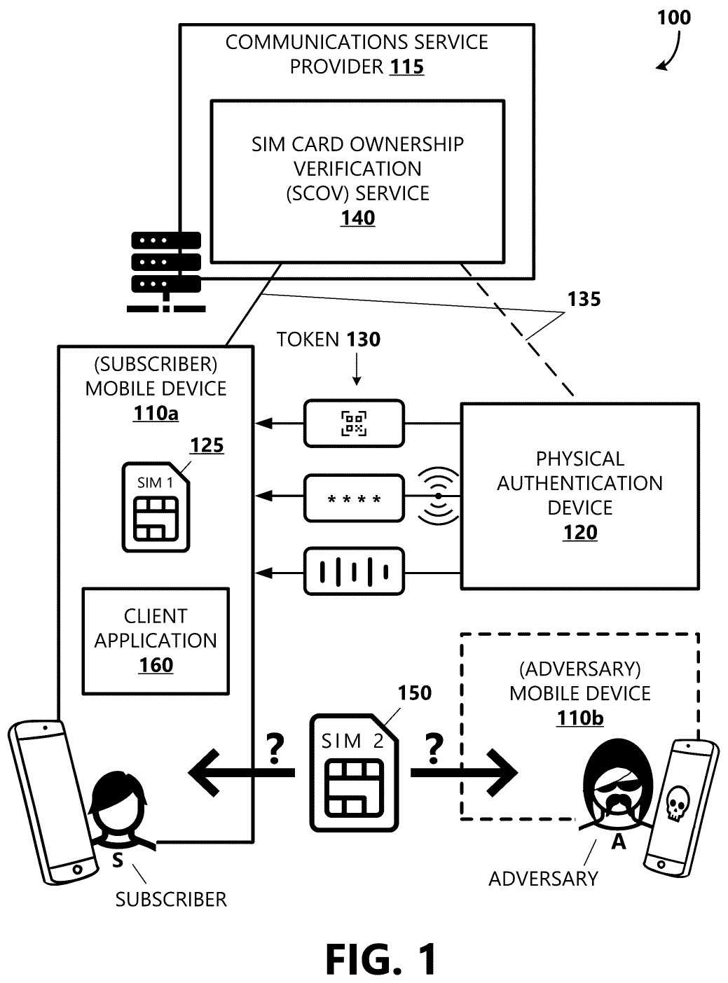

With reference now to FIG. 1, an example communications system 100 is depicted in which proximity-based SIM card subscriber authentication is implemented. The communications system 100 includes various elements used for wireless and wired communications over a network or a combination of networks 135, where a communications service provider 115 is a trusted entity responsible for managing mobile network services over the network(s) 135. In examples, different elements and components of the communications system 100 communicate using wireless communications, such as cellular networks (e.g., 4G, LTE, or 5G), satellite connections, etc., and/or hardwired connections, such as fiber optics, T1, cable, DSL, high-speed trunks, and/or telephone lines.

A subscriber is subscribed to receive communications services (e.g., calls, texts, and/or data) from the communications service provider 115 and has a subscriber account with the communications service provider 115. The communications service provider 115 may include a single communications service provider or multiple communications services providers. The subscriber may be a primary or a secondary subscriber of a service plan on the subscriber account. For instance, a subscriber account may include multiple subscribers of multiple service plans. In examples, Subscriber Identity Module (SIM) cards are used in subscriber mobile devices 110a and by the communications service provider 115 to identify and authenticate subscribers and to establish a connection between subscriber mobile devices 110a and the network 135. Subscriber mobile devices 110a may include a smartphone, features phone (e.g., basic or non-smartphone), tablet, laptop, Internet of Things (IOT) device, or other type of communication device. Subscriber mobile devices 110a and adversary mobile devices 110b (generally, mobile devices 110) communicate on the network(s) 135 using communications protocols, such as time division multiple access (TDMA), code division multiple access (CDMA), global systems for mobile (GSM) communications, personal communications systems (PCS), WLAN, WiMAX, or other cellular and data communications protocols and standards.

Each SIM card has a unique identification number (e.g., an International Mobile Subscriber Identity (IMSI)) that uniquely identifies a subscriber and that is associated with/linked to a subscriber phone number. A SIM card may be insertable and removeable from a mobile device 110 or may be embedded into a mobile device 110 (e.g., an embedded SIM (eSIM)). In examples, the SIM card IMSI number is stored in association with other subscriber account information (e.g., subscriber phone number, plan details, billing information) by one or a combination of databases of the communications service provider 115. For instance, the communications service provider 115 includes local and/or cloud-based servers and databases for managing subscriber accounts, managing network access control, etc. According to an aspect, and as will be described in further detail below, a SIM card ownership verification (SCOV) service 140 operates on one or more communications service provider servers and provides proximity-based SIM card subscriber authentication for preventing unauthorized SIM card transfers. The SCOV service 140 communicates with a client application 160 operating on a subscriber mobile device 110a. The client application 160 may be implemented as a web browser or a mobile application on the subscriber mobile device 110a and communicates with the SCOV service 140 over the network(s) 135 using standard protocols, such as HTTP/HTTPS for web-based communication, or custom protocols for application-specific interactions.

In examples, a first SIM card 125 is installed or embedded in a subscriber mobile device 110a and linked to the subscriber phone number by the communications service provider 115 (e.g., the phone number and first SIM card may be associated with each other in account file(s) stored by, or accessible to, the communications service provider 115. When the subscriber uses the subscriber mobile device 110a with the first SIM card 125 to connect to the service provider network 135, the IMSI from the first SIM card 125 is communicated to the communications service provider 115. Additionally, the first SIM card 125 is challenged to generate an authentication key using a secret key stored on the first SIM card 125 to verify the SIM card is valid and corresponds to the IMSI it claims to represent. When the first SIM card 125 is authenticated, the communications service provider 115 may grant the subscriber mobile device 110a access to services to which the subscriber is subscribed (e.g., voice calls, text messaging, data services) via the service provider network 135.

In some example scenarios, a second SIM card 150 is obtained by the subscriber. For instance, the subscriber may receive the second SIM card 150 as a replacement to the first SIM card 125 or receive a new subscriber mobile device 110a including the second SIM card 150. The second SIM card 150, in some examples, is received from a third party. In other examples, the second SIM card 150 may be received from the communications service provider 115. Upon obtaining the second SIM card 150, a SIM card change request may be made to transfer the subscriber phone number from the first SIM card 125 to the second SIM card 150. To perform the SIM card change, the IMSI of the second SIM card 150 is added to the subscriber account and linked to the subscriber phone number by the communications service provider 115. Additionally, the IMSI of the first SIM card 125 is unlinked from the subscriber phone number. In some examples, unlinking the subscriber phone number from the first SIM card 125 may deactivate the first SIM card 125 and cause the subscriber mobile device 110a on which it is installed to no longer receive and/or make calls, send and/or receive texts, and/or access data services of communications service provider 115.

In other example scenarios, the second SIM card 150 is obtained by an adversary rather than the subscriber. In an attempt to have the subscriber phone number transferred to the second SIM card 150 held by the adversary, a SIM card change request may be initiated by the adversary. For instance, the adversary may impersonate the subscriber, such as by providing stolen or otherwise maliciously acquired personal information of the subscriber to the communications service provider 115 to activate the second SIM card 150 on an adversary mobile device 110b.

According to aspects, to prevent malicious/unauthorized SIM card changes, the SCOV service 140, the client application 160, and a physical authentication device 120 are implemented to provide proximity-based SIM card subscriber authentication. When a SIM card change request is received by the communications service provider 115 to transfer a subscriber phone number from a first SIM card 125 to a second SIM card 150, the SCOV service 140 initially activates the second SIM card 150 in a first state, referred to herein as a locked state. In the locked state, the mobile device 110 on which the second SIM card 150 is installed is restricted from access to one or more service provider services. For example, in the locked state, the mobile device 110 on which the second SIM card 150 is installed may be provided access to only a limited, walled-garden of data and services available from the service provider 115. In some examples, the mobile device 110 is prevented from receiving calls and/or text messages at the subscriber's phone number. For instance, when in the locked state, the mobile device 110 may be unable to intercept MFA codes sent to the subscriber's phone number, thereby preventing access to the user's sensitive accounts. In other examples, additional features may be disabled.

According to aspects, subscriber ownership of the second SIM card 150 is verified by the SCOV service 140 using a token 130 provided to the SCOV service 140 via the subscriber mobile device 110a, In examples, the token 130 is obtained from the physical authentication device 120 when the subscriber mobile device 110a is within proximity of the physical authentication device 120. For instance, “proximity” describes a physical distance between the subscriber mobile device 110a and the physical authentication device 120, where the physical distance is within a threshold distance that verifies the subscriber is physically present with the second SIM card 150 at the time of authentication. The threshold distance may vary based on the technologies used to present the token 130 to the subscriber mobile device 110a.

In some examples, the token 130 is stored by or can be accessed by the physical authentication device 120 and presented to the subscriber mobile device 110a when the subscriber mobile device 110a is within proximity to the physical authentication device 120. For instance, the token 130 may be a unique code or identifier that represents the physical authentication device 120 or information stored about the subscriber by the physical authentication device 120 and the communications service provider 115 (e.g., the subscriber phone number, subscriber address, a government-issued identifier of the subscriber). In other examples, the token 130 is generated by the physical authentication device 120. The token 130 may be a cryptographic value generated using an encryption algorithm and authentication protocols, such as HMAC (Hash-based Message Authentication Code), and/or challenge-response authentication protocols, such as Kerberos. For instance, the token 130 may be a numeric code generated based on one or more elements, such as key with which the physical authentication device 120 is seeded and known by the SCOV service 140, an identifier of the physical authentication device 120 (e.g., a SIM card identifier, a phone number, a serial number), and/or other elements. The token 130 may be encoded into a wireless signal emitted from the physical authentication device 120, a visual code displayed on a screen of the physical authentication device 120, or audible tones played by a speaker of the physical authentication device 120.

When the token 130 is transmitted using wireless signals, the wireless signals may be short-or medium-range signals, such as near field communication (NFC) signals, BLUETOOTH signals, BLUETOOTH Low Energy (BLE) signals, or other type of wireless signals that are transmitted up to the threshold distance. For instance, the subscriber mobile device 110a with the second SIM card 150 may receive the wireless signals when the physical authentication device 120 is within a proximate range (e.g., 4-20 centimeters to up to 100 meters) of the subscriber mobile device 110a for the signals to be received. Wireless signals may be received by an NFC, BLUETOOTH, BLE, or another type of wireless communication module installed on the subscriber mobile device 110a. When the token 130 is presented as a visual code, the token 130 may be encoded into a Quick Response (QR) code or another type of image that may be received by a camera installed on the subscriber mobile device 110a. Moreover, when the token 130 is presented as a pattern of audible tones, the audible tones may be received by a microphone installed on the subscriber mobile device 110a. The token 130 may be represented in other data formats, presented to, and received by the subscriber mobile device 110a. The physical authentication device 120 may be implemented as various types of devices, where the physical authentication device 120 has one or more wireless transmission modules, such as an NFC module, a BLUETOOTH module, and/or a BLE module, a display, and/or a speaker for presenting the token 130 to the subscriber mobile device 110a.

In some example implementations, the physical authentication device 120 is implemented as an Automatic Teller Machine (ATM). For instance, the ATM is a secure self-service banking/finance terminal operated by a bank or financial institution, where the bank or financial institution is an entity trusted by the communications service provider 115 and which has access to information representing the subscriber (e.g., a government-issued identifier, the subscriber phone number). When the physical authentication device 120 is implemented as an ATM, the subscriber may first insert their bank card (e.g., a debit or credit card) into a card reader interface. A magnetic stripe or chip in the card is read by the card reader interface and the subscriber may be prompted to enter a Personal Identification Number (PIN) associated with the card. After successful card and PIN authentication, the ATM authenticates the subscriber and establishes a secure communication link with the subscriber's bank or financial institution. The subscribers bank or financial institution may be the same as or different from the bank or financial institution operating the ATM. In some examples, the ATM has a display, speaker, or other user interface via which various options are presented. The options may include financial transaction options, such as cash withdrawal, balance inquiry, deposit, funds transfer, bill payment, etc. The options may further include a proximity-based SIM card subscriber authentication option. In some examples, selection of the proximity-based SIM card subscriber authentication option may trigger the ATM to generate and/or present a token 130. In some implementations, selection of the proximity-based SIM card subscriber authentication option may trigger the ATM to unlock an NFC module so that it is in a state where it can communicate with the subscriber mobile device 110a for receiving a token request from the subscriber mobile device 110a and/or to broadcast a token 130.

In other example implementations, the physical authentication device 120 is implemented as a mobile device 110 affiliated with the subscriber (referred to as a subscriber-affiliated mobile device). For instance, the subscriber-affiliated mobile device 110 may be another subscriber mobile device 110a used by another individual on a same subscriber account as the subscriber. The subscriber-affiliated mobile device 110, for example, has a phone number and an activated and unlocked SIM card linked to the subscriber account. In other examples, the subscriber-affiliated mobile device 110 is a first subscriber mobile device 110a on which the first SIM card 125 is installed, and where the second SIM card 150 is installed on a second subscriber mobile device 110a.

In yet other example implementations, the physical authentication device 120 is implemented as an authentication fob, card, or other portable object. In some examples, the subscriber may obtain the second SIM card 150 from a SIM card source and then request a SIM card change with the communications service provider 115, where the subscriber is then provided with a portable physical authentication device 120 by the communications service provider 115. In some examples, the portable physical authentication device 120 may be shipped to an address on the subscriber account. In other examples, the subscriber may present personal identifying information in a store (or other physical location) of the communications service provider 115 to obtain the physical authentication device 120.

In examples, when a token 130 is presented by the physical authentication device 120 and received by the subscriber mobile device 110a, the client application 160 on the subscriber mobile device 110a performs an action to verify the token 130 with the SCOV service 140 as proof of subscriber ownership of the second SIM card 150. The action may be based on the format of the token 130, the type of client application 160 installed on the subscriber mobile device 110a, and/or settings of the subscriber mobile device 110a. In some examples, the token 130 may be encoded as a parameter in a URL and inserted in an address bar of a web browser (e.g., client application 160). The client application 160 may send the URL, with the token parameter included, to the SCOV service 140. The SCOV service 140 may parse the URL to extract and then verify the token 130. In other examples, such as when the client application 160 is implemented as a mobile application, the token 130 and the IMSI of the second SIM card 150 may be encoded in a header or body of an Application Programming Interface (API) request to the SCOV service 140. The SCOV service 140 may extract and verify the token 130.

Some example verification procedures may include verifying the token's authenticity and validity using cryptographic methods and determining if the token 130 matches physical authentication device information stored in a database. The SCOV service 140 may further verify that the SIM card identifier from the received token communication matches the IMSI of the second SIM card 150 stored in the subscriber account. When the SCOV service 140 verifies the token 130 and second SIM card identifier, physical SIM card ownership by the subscriber may be verified. According to aspects, when physical SIM card ownership by the subscriber is successfully verified, the SCOV service 140 activates the second SIM card 150 in a second state, herein referred to as an unlocked state. In the unlocked state, previously disabled functions are enabled. For instance, the subscriber mobile device 110b on which the second SIM card 150 is installed may be able to receive calls and text messages. In some examples, calls and/or text messages that are received while the second SIM card 150 is locked (i.e., in the locked state) are queued and then released when the second SIM card 150 is unlocked (i.e., in the unlocked state).

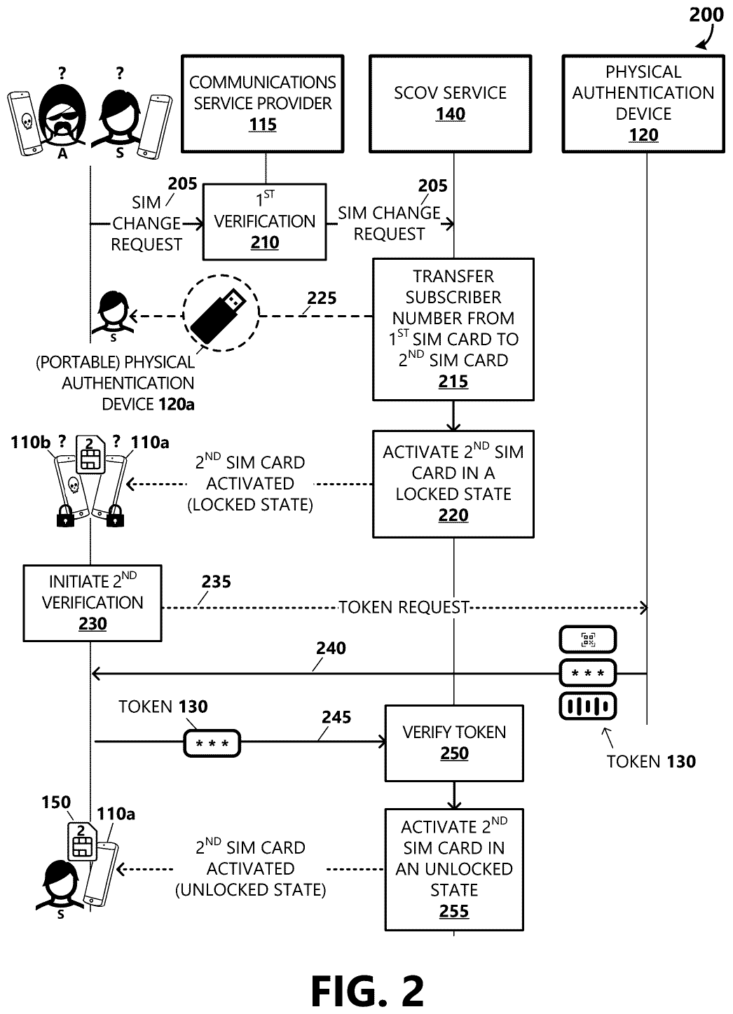

With reference now to FIG. 2, an example data flow 200 for providing proximity-based SIM card subscriber authentication is depicted. In some examples, proximity-based SIM card subscriber authentication is initiated when a SIM card change request 205 is received by the communications service provider 115. For instance, the SIM card change request 205 is directed to transferring a subscriber phone number from a first SIM card 125 installed on a subscriber mobile device 110a to a second SIM card 150. According to examples, the SIM card change request 205 may be accompanied by personal information of the subscriber that is used to successfully answer security questions that allow for the SIM card change request 205 to be allowed by the communications service provider 115. In some cases, the SIM card change request 205 is initiated by the subscriber. In other cases, the SIM card change request 205 is initiated by an adversary using personal information of the subscriber to fraudulently transfer the subscriber phone number to an adversary mobile device 110b. In some implementations, upon completion of a first verification 210 (e.g., of the subscriber personal information), the communications service provider 115 directs the SIM card change request 205 to the SCOV service 140 to perform the SIM card change request 205. In other implementations, the SIM card change request 205 is received by the SCOV service 140, and the SCOV service performs the first verification 210 to allow the requested SIM card transfer.

Upon successful completion of the first verification 210, the subscriber phone number may be transferred (215) from the first SIM card 125 to the second SIM card 150. For instance, the phone number in the subscriber account may be unlinked from the first SIM card 125 and transferred and linked to the second SIM card 150. Additionally, the second SIM card 150 is activated in a locked state (220) until completion of a second verification. According to an aspect, the second verification includes proximity-based SIM card subscriber authentication using a physical authentication device 120. In some implementations, the subscriber is provided (225) a portable physical authentication device 120 (e.g., to an address on the subscriber account) that is used for the second verification. In other implementations, another type of physical authentication device 120 is used, such as a subscriber-affiliated physical authentication device or an ATM.

In some example implementations, the second verification is initiated (230) by the subscriber mobile device 110a. For instance, a client application 160 on the subscriber mobile device 110a may be opened and/or an option may be selected via a user interface presented by the client application 160 to initiate the second verification. In a first example, the subscriber mobile device 110a and the physical authentication device 120 have NFC capabilities, where opening the client application 160 and/or a user selection may trigger activation of an NFC module on the subscriber mobile device 110a, which creates a magnetic radio frequency (RF) field around the subscriber mobile device 110a. When the physical authentication device 120 is positioned within a threshold distance (e.g., a few centimeters) of the subscriber mobile device 110a, the magnetic field induces an electric current that powers and activates an NFC module in the physical authentication device 120. In some examples, the client application 160 broadcasts (235) a request for a token 130 in a wireless signal, which is received by the NFC module in the physical authentication device 120. In a second example, the subscriber mobile device 110a and the physical authentication device 120 have BLUETOOTH or BLE capabilities, where the subscriber mobile device 110a and the physical authentication device 120 establish a BLUETOOTH or BLE connection. For instance, the client application 160 may transmit (235) a request for a token 130 from the physical authentication device 120 via a BLUETOOTH or BLE signal.

In some examples, in response to the NFC interaction initiated by the subscriber mobile device 110a and/or received token request, an event is triggered that causes a user notification or prompt to be displayed on a screen of the physical authentication device 120. For instance, the user notification or prompt may ask the user (e.g., the subscriber or another subscriber on the subscriber account) of the physical authentication device 120 for user consent or action. Options, such as “Allow” or “Deny” or a request for user input of subscriber information may be presented. For instance, when the user consents to the request or provides subscriber information, a token 130 may be generated and shared (240) with the subscriber mobile device 110a. For instance, the token 130 may be broadcast in the RF field, transmitted via BLUETOOTH or BLE signals, displayed as a visual representation on a display of the physical authentication device 120, or played as an audible representation via a speaker or other tone generation mechanism included in the physical authentication device 120.

In other example implementations, the second verification is initiated (230) by the physical authentication device 120. For instance, when the physical authentication device 120 is implemented as a subscriber-affiliated mobile device, an option to perform the second verification may be presented to the affiliated subscriber as a link (e.g., in an email, SMS, or notification) or an option may be presented in a user interface by the client application 160 operating on the subscriber-affiliated mobile device. Selection of the link or option may trigger the subscriber-affiliated mobile device to generate a token 130 and/or broadcast, display, play, or otherwise share (240) the generated token 130 with the subscriber mobile device 110a. When the physical authentication device 120 is implemented as an ATM, the physical authentication device 120 may present a proximity-based SIM card subscriber authentication option. In some examples, selection of the proximity-based SIM card subscriber authentication option may trigger the ATM to generate and/or share a token 130. The token 130 may be encoded in a wireless signal, visual code, or audible code.

According to an aspect, the subscriber mobile device 110a receives the token 130 from the physical authentication device 120, where the token 130 serves as proof of physical proximity of the subscriber to the physical authentication device 120. In some implementations, the token 130 is included in a URL that is used by the client application 160 on the subscriber mobile device 110a to communicate with the SCOV service 140. In other implementations, the token 130 is included in an API request to the SOV service 140. The API request may include the token 130 as part of the request payload, in the request header, or using a specified authentication method.

According to aspects, the SCOV service 140 receives and verifies (250) the token 130 is valid based on identifying the communication is received from the second SIM card 150 and by verifying the token's authenticity using cryptographic methods. When the token 130 and second SIM card 150 are verified, the SCOV service 140 may determine the second SIM card 150 is in physical proximity of the subscriber and, thus, physical SIM card subscriber ownership is verified. The second verification may be completed and the second SIM card 150 is activated (255) in the unlocked state. For instance, the subscriber can receive calls and text messages on the subscriber mobile device 110a with the second SIM card 150.

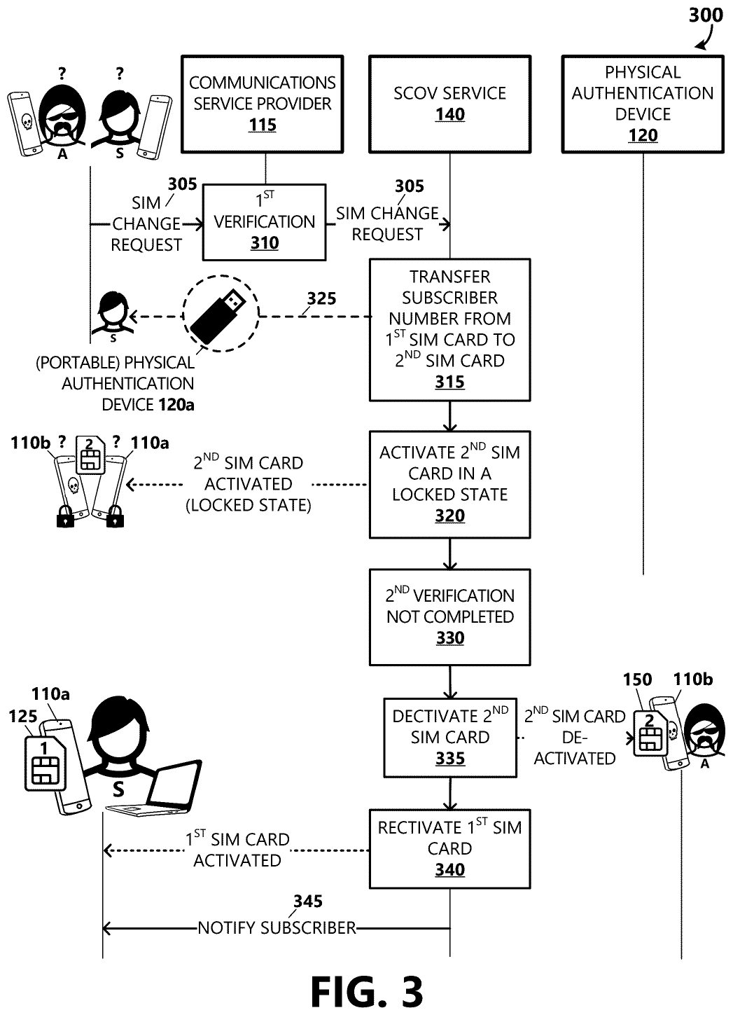

With reference now to FIG. 3, another example data flow 300 for providing proximity- based SIM card subscriber authentication is depicted. In some examples, proximity-based SIM card subscriber authentication is initiated when a SIM card change request 305 directed to transferring a subscriber phone number from a first SIM card 125 installed on a subscriber mobile device 110a to a second SIM card 150 is received by the communications service provider 115. According to examples, the SIM card change request 305 may be accompanied by personal information of the subscriber to answer security questions for allowing the SIM card change request 305. In the example data flow 300 depicted in FIG. 3, the SIM card change request 305 is initiated by an adversary using personal information of the subscriber to fraudulently transfer the subscriber phone number to an adversary mobile device 110b.

In some examples, the first verification 310 is completed using subscriber personal information and the subscriber phone number may be transferred (315) from the first SIM card 125 to the second SIM card 150. For instance, the phone number in the subscriber account linked to the first SIM card 125 is transferred and linked to the second SIM card 150. Additionally, the second SIM card 150 is activated in a locked state (320) until completion of a second verification using proximity-based SIM card subscriber authentication. In some implementations, the subscriber is provided (325) a portable physical authentication device 120 (e.g., to an address on the subscriber account) in response to the SIM card change request.

In some example implementations, a determination (330) may be made by the SCOV service 140 that the second verification has not been completed. For instance, the second verification may not be completed within a time threshold of the SIM card change request or phone number transfer. When proximity-based SIM card subscriber authentication is not completed within the time threshold, the second SIM card 150 may be deactivated (335) (e.g., unlinked from the subscriber phone number). For instance, an adversary mobile device 110b on which the second SIM card 150 may be installed may be further restricted from accessing any services to which the subscriber is subscribed (e.g., making and receiving voice calls, text messaging, data services). In some examples, the first SIM card 125 may be reactivated (340) (e.g., linked to the subscriber phone number). In some implementations, the first SIM card 125 is reactivated in an unlocked state, where the subscriber mobile device 110a on which the first SIM card 125 is installed may be enabled to access subscribed services. In other implementations, the first SIM card 125 is reactivated in a locked state, where proximity-based SIM card subscriber authentication may be required to be completed to reactivate the first SIM card 125 in the unlocked state. In further examples, the subscriber may be notified (345) by the SCOV service 140 about the SIM card change request or transfer, uncompleted second verification of the second SIM card 150, and/or need to complete proximity-based SIM card subscriber authentication to unlock the first SIM card 125.

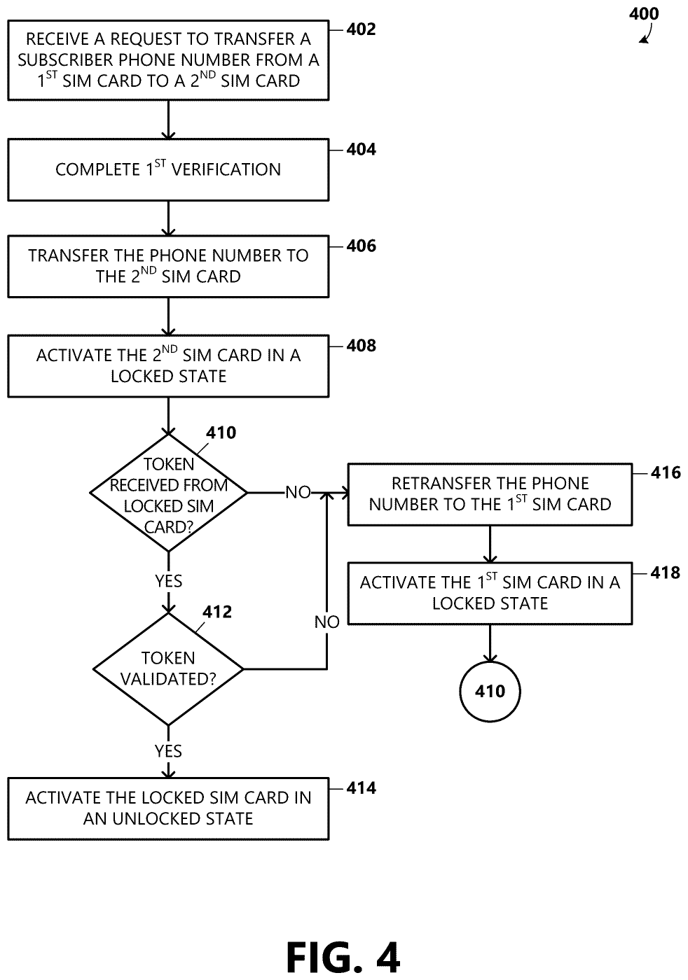

FIG. 4 is a flowchart illustrating operations of a method 400 for providing proximity-based SIM card subscriber authentication according to an example. For instance, operations of the method 400 may be performed by the SCOV service 140. At operation 402, a SIM card change request is received, where the request corresponds to transferring a subscriber phone number from a first SIM card 125 to a second SIM card 150.

At operation 404, a first verification may be completed. For instance, the first verification may include verifying personal information of the subscriber against subscriber information stored in a database. When the first verification is completed, at operation 406, the subscriber phone number may be transferred and linked to the second SIM card 150. At operation 408, the second SIM card 150 is activated in a locked state, where the mobile device 110 on which the second SIM card 150 is installed may be restricted from receiving texts and calls. In examples, texts and/or calls directed to the subscriber phone number while the second SIM card 150 is locked may be queued. In further examples, the first SIM card 125 may be deactivated/unlinked from the subscriber phone number.

At decision operation 410, a determination is made as to whether a token 130 is received in association with the locked SIM card (e.g., the second SIM card 150). In examples, the token 130 is accompanied by the IMSI of the second SIM card 150, which may serve as proof of physical proximity of the second SIM card 150, and thus the subscriber, to the physical authentication device 120.

When the token 130 is received, the SCOV service 140 may attempt to validate the token 130 at decision operation 412 based on stored information about the physical authentication device 120. When the token 130 is validated, the SCOV service 140 activates the second SIM card 150 in an unlocked state at operation 414, where the subscriber mobile device 110a on which the second SIM card 150 is installed may be allowed to receive texts and calls. In examples, texts and/or calls (or related call logs and voicemails) directed to the subscriber phone number while the second SIM card 150 was in the locked state may be released and received by the subscriber mobile device 110a.

In some examples, when a token 130 is not received and/or cannot be validated within a time threshold of transferring the subscriber number, the method 400 may proceed to operation 416, where the subscriber phone number may be retransferred to the first SIM card 125. In some examples, the second SIM card 150 may be deactivated from the subscriber account. In further examples, the subscriber may be notified (e.g., via email to a subscriber email address) about the SIM card change request and/or retransfer of the subscriber number.

In some examples, at operation 418, the first SIM card 125 may be reactivated in a locked state, where the mobile device 110 on which the first SIM card 125 is installed may be restricted from receiving texts and calls. For instance, the second verification may need to be completed for the first SIM card 125 to be reactivated in an unlocked state.

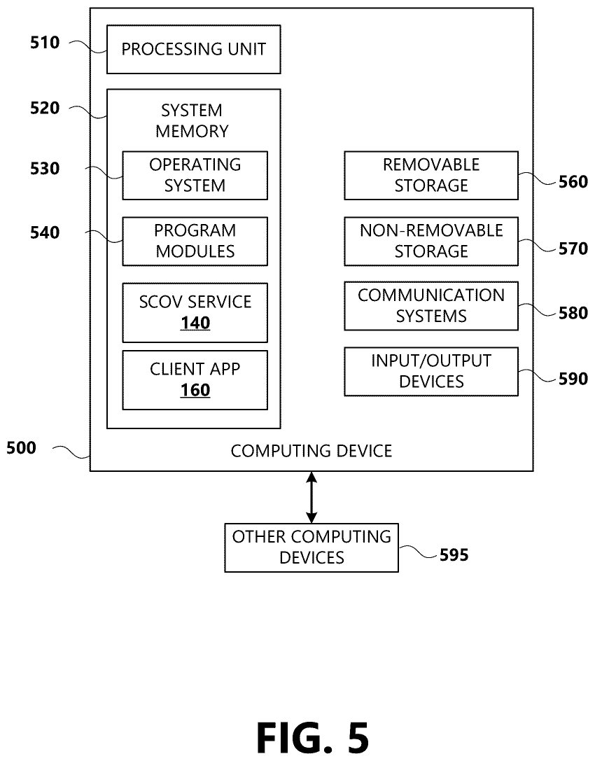

FIG. 5 is a system diagram of a computing device 500 according to an example. The computing device 500, or various components and systems of the computing device 500, may be integrated or associated with the SCOV service 140. As shown in FIG. 5, the physical components (e.g., hardware) of the computing device 500 are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for performing one more of the operations of the methods described above for providing proximity-based SIM card subscriber authentication. A number of different program modules and data files may be stored in the system memory 520. While executing on the processing unit 510, the program modules 540 may perform the various processes described above. One example program module 540 includes the SCOV service 140. Another example program module 540 includes the client application 160.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595 such as, for example, routing engines, gateways, signings systems and the like. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media is non-transitory and tangible and does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
receiving a request to transfer a subscriber phone number from a first Subscriber Identity Module (SIM) card to a second SIM card;
linking, in an account of a subscriber, the subscriber phone number to the second SIM card;
activating the second SIM card in a locked state;
receiving, from a mobile device including the second SIM card, a token obtained from a physical authentication device within proximity to the mobile device;
verifying the token; and
activating the second SIM card in an unlocked state.

2. The method of claim 1, wherein activating the second SIM card in the locked state comprises disabling the mobile device including the second SIM card from receiving calls and text messages.

3. The method of claim 1, wherein verifying the token comprises matching the token to an identifier of the physical authentication device.

4. The method of claim 3, further comprising:
storing an identifier of the physical authentication device in the account of the subscriber; and
providing the physical authentication device to the subscriber.

5. The method of claim 1, wherein verifying the token comprises matching the token to subscriber information known by the physical authentication device.

6. The method of claim 1, wherein prior to linking the subscriber phone number to the second SIM card, verifying subscriber personal information included with the request against subscriber information stored in a database.

7. The method of claim 1, wherein activating the second SIM card in the unlocked state comprises enabling the mobile device including the second SIM card to receive calls and text messages.

8. The method of claim 1, wherein receiving the token obtained from the physical authentication device within proximity to the mobile device comprises receiving the token obtained from one of:
an authentication fob;
an authentication card;
an Automatic Teller Machine (ATM); or
a subscriber-affiliated mobile device of another subscriber included in the account of the subscriber.

9. A system, comprising:
at least one processing unit; and
memory storing instructions that, when executed by the at least one processing unit, cause the system to:
receive a request to transfer a subscriber phone number included in an account of a subscriber from a first Subscriber Identity Module (SIM) card to a second SIM card;
link the subscriber phone number to the second SIM card;
activate the second SIM card in a locked state;
receive, from a mobile device including the second SIM card, a token obtained from a physical authentication device within proximity to the mobile device;
verify the token; and
activate the second SIM card in an unlocked state.

10. The system of claim 9, wherein the locked state disables the mobile device including the second SIM card from receiving calls and text messages.

11. The system of claim 9, wherein the token represents at least one of:
an identifier of the physical authentication device; and
subscriber information known by the physical authentication device.

12. The system of claim 9, wherein the physical authentication device is one of:
an authentication fob;
an authentication card;
an Automatic Teller Machine (ATM); or
a subscriber-affiliated mobile device of another subscriber included in the account of the subscriber.

13. The system of claim 12, wherein the token is obtained from the physical authentication device within proximity to the mobile device in one of:
a near field communication (NFC) signal;
a BLUETOOTH signal;
a BLUETOOTH LOW ENERGY signal;
a visual code; or
an audible code.

14. The system of claim 9, wherein the unlocked state enables the mobile device including the second SIM card to receive calls and text messages.

15. A method, comprising:
receiving a request to transfer a subscriber phone number from a first Subscriber Identity Module (SIM) card to a second SIM card;
linking, in an account of a subscriber, the subscriber phone number to the second SIM card;
activating the second SIM card in a locked state;
determining whether a valid token is received from a mobile device including the second SIM card within a time threshold of receiving the request, wherein the valid token is obtained from a physical authentication device within proximity to the mobile device; and
when the valid token is received, activating the second SIM card in an unlocked state.

16. The method of claim 15, wherein when the valid token is not received within the time threshold:
linking the subscriber phone number to the first SIM card;
activating the first SIM card in the locked state;
receiving a valid token from a mobile device including the first SIM card within a time threshold of receiving the request, wherein the valid token is obtained from a physical authentication device within proximity to the mobile device including the first SIM card; and
when the valid token is received, activating the first SIM card in the unlocked state.

17. The method of claim 16, wherein activating the first SIM card and the second SIM card in the locked state comprises disabling the mobile device including the first second SIM card and the mobile device including the second SIM card from receiving calls and text messages.

18. The method of claim 16, wherein determining whether the valid token is received from the mobile device including the second SIM card or from the mobile device including the first SIM card comprises:
matching the valid token to an identifier of the physical authentication device; or
matching the valid token to subscriber information known by the physical authentication device.

19. The method of claim 15, wherein prior to linking the subscriber phone number to the second SIM card, completing a verification of personal subscriber information provided by the subscriber.

20. The method of claim 15, wherein receiving the valid token from the mobile device including the first SIM card comprises receiving the valid token obtained from one of:
an authentication fob;
an authentication card;
an Automatic Teller Machine (ATM); or
a subscriber-affiliated mobile device of another subscriber included in the account of the subscriber.
